(19) United States
(12) Patent Application Publication
(10) Pub. No.: US 2018/0236996 A1
(43) Pub. Date: Aug. 23, 2018

(54) HYBRID VEHICLE

(71) Applicant: TOYOTA JIDOSHA KABUSHIKI KAISHA, Toyota-shi (JP)

(72) Inventors: Hidehiro Oba, Nagakute-shi (JP); Eiji Maeda, Hadano-shi (JP)

(73) Assignee: TOYOTA JIDOSHA KABUSHIKI KAISHA, Toyota-shi (JP)

(21) Appl. No.: 15/880,937

(22) Filed: Jan. 26, 2018

(30) Foreign Application Priority Data
Feb. 20, 2017 (JP) 2017-029014

(51) Int. Cl. B60W 20/15; B60W 40/12; B60W 10/06

(52) U.S. Cl. CPC B60W 20/15; B60W 40/12; B60W 2710/0677; B60W 2510/244; B60W 2510/0666; B60W 10/06

(57) ABSTRACT

A hybrid vehicle includes: an engine; a rotating electric machine; a battery; and a controller that is configured to be capable of calculating a battery equivalent fuel efficiency. While the engine is in operation, the controller searches charge/discharge power to/from the battery at which a vehicle fuel consumption amount that is calculated in consideration of a fuel consumption amount in the engine and an equivalent fuel consumption amount that is determined by a product of the battery equivalent fuel efficiency and the charge/discharge power is minimum, and causes the engine to output a value that is calculated by adding the searched charge/discharge power to requested power from a user.

### INCORPORATION BY REFERENCE

The disclosure of Japanese Patent Application No. 2017-029014 filed on Feb. 20, 2017 including the specification, drawings and abstract is incorporated herein by reference in its entirety.

### BACKGROUND

### 1. Technical Field

This disclosure relates to a hybrid vehicle that can run on power from at least one of an engine and a rotating electric machine.

### 2. Description of Related Art

Japanese Patent Application Publication No. 11-229916 (JP 11-229916 A) discloses a hybrid vehicle that is equipped with an engine, a motor that is mechanically connected to driving wheels, and a battery that is electrically connected to the motor. In this hybrid vehicle, a motor running mode in which the vehicle runs with the engine stopped is selected when an equivalent fuel consumption rate of the battery is lower than a fuel consumption rate of the engine, and an engine running mode in which the vehicle runs with the engine operated is selected when the equivalent fuel consumption rate of the battery is higher than the fuel consumption rate of the engine.

### SUMMARY

In the hybrid vehicle that is disclosed in JP 11-229916 A, it is determined whether the motor running mode or the engine running mode is selected using the fuel consumption rate of the engine and the equivalent fuel consumption rate of the battery.

However, there is no mention of what value should be set as charge/discharge power to/from the battery when the engine running mode has been selected (when the engine is in operation) in JP 11-229916 A. It is, therefore, concerned that a fuel consumption amount cannot be optimized while the engine is in operation.

This disclosure provides a hybrid vehicle in which a fuel consumption amount can be optimized while an engine is in operation.

A hybrid vehicle according to an aspect of this disclosure includes: an engine; a rotating electric machine; a battery that is electrically connected to the rotating electric machine; and a controller that is configured to be capable of calculating a battery equivalent fuel efficiency, which is a ratio of an amount of fuel that is consumed in the engine to charge the battery to a total electric power amount that is stored in the battery. The hybrid vehicle can run on power from at least one of the engine and the rotating electric machine. While the engine is in operation, the controller searches charge/discharge power to/from the battery at which a vehicle fuel consumption amount that is calculated in consideration of a fuel consumption amount in the engine and an equivalent fuel consumption amount that is determined by a product of the battery equivalent fuel efficiency and the charge/discharge power is minimum, and causes the engine to output a value that is calculated by adding the searched charge/discharge power to requested power from a user.

In the hybrid vehicle according to the above configuration, while the engine is in operation, battery charge/discharge power at which a vehicle fuel consumption amount that is calculated in consideration of a fuel consumption amount in the engine and an equivalent fuel consumption amount of the battery is minimum is searched, and a value that is calculated by adding the searched charge/discharge power to requested power is output from the engine. Thus, while the engine is in operation, the fuel consumption amount in the entire vehicle can be optimized in consideration of not only the fuel consumption amount in the engine but also the equivalent fuel consumption amount of the battery.

In the above aspect, when the requested power is lower than reference power at which the engine has an optimal heat efficiency value, the controller may set a value that is calculated by subtracting a battery equivalent fuel consumption amount that is determined by a product of the battery equivalent fuel efficiency and charge power that is charged into the battery from a fuel consumption amount that is necessary for the engine to output power that is calculated by adding the charge power to the requested power as a first vehicle fuel consumption amount, search the charge power at which the first vehicle fuel consumption amount is minimum as optimal charge power, and cause the engine to output a value that is calculated by adding the optimal charge power to the requested power.

According to the above configuration, when the requested power is lower than the reference power, the engine power is made closer to the reference power (the heat efficiency of the engine is made closer to an optimal value) by adding the charge power to the battery to the requested power. At this time, the charge power at which a first vehicle fuel consumption amount that is calculated in consideration of the fuel consumption amount in the engine and the equivalent fuel consumption amount of the battery is minimum is searched as optimal charge power, and a value that is calculated by adding the optimal charge power to the requested power is output from the engine. Thus, while the engine is in operation, the fuel consumption amount in the entire vehicle can be optimized in consideration of not only the fuel consumption amount in the engine but also the equivalent fuel consumption amount that is stored in the battery.

In the above aspect, when the requested power is higher than reference power at which the engine has an optimal heat efficiency value, the controller may set a value that is calculated by adding a battery equivalent fuel consumption amount that is determined by a product of the battery equivalent fuel efficiency and discharge power that is discharged from the battery to a fuel consumption amount that is necessary for the engine to output power that is calculated by subtracting the discharge power from the requested power as a second vehicle fuel consumption amount, search the discharge power at which the second vehicle fuel consumption amount is minimum as optimal discharge power, and cause the engine to output a value that is calculated by subtracting the optimal discharge power from the requested power.

According to the above configuration, when the requested power is higher than the reference power, the engine power can be made closer to the reference power (the heat efficiency of the engine can be made closer to an optimal value) by subtracting the discharge power from the battery from the requested power. At this time, the discharge power at which a second vehicle fuel consumption amount that is calculated in consideration of the fuel consumption amount in the engine and the equivalent fuel consumption amount of the battery is minimum is searched as optimal discharge power, and a value that is calculated by subtracting the optimal discharge power from the requested power is output from the engine. Thus, while the engine is in operation, the fuel consumption amount in the entire vehicle can be optimized in consideration of not only the fuel consumption amount in the engine but also the equivalent fuel consumption amount that is consumed by the battery.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an entire configuration diagram of a vehicle;

FIG. 2 is a flowchart (first) that illustrates one example of a processing procedure by an ECU;

FIG. 3 is a graph for explaining one example of engine power control;

FIG. 4 is a graph that illustrates a correspondence relationship between engine power and an engine fuel efficiency h;

FIG. 5 is a graph that schematically illustrates one example of a correspondence relationship among engine power, engine electric generation power Pb and an engine fuel efficiency h;

FIG. 6 is a graph that schematically illustrates one example of a correspondence relationship among engine power, engine electric generation power Pb and “h·Pe”;

FIG. 7 is a graph that schematically illustrates one example of a correspondence relationship among engine power, engine electric generation power Pb and “h−F·η”;

FIG. 8 is a graph that schematically illustrates one example of a correspondence relationship among engine power, engine electric generation power Pb and “(h−F·η)·Pb”;

FIG. 9 is a graph that schematically illustrates one example of a correspondence relationship among engine power, engine electric generation power Pb and vehicle fuel consumption amount Q1;

FIG. 10 is a graph that schematically illustrates one example of a correspondence relationship among engine power, motor assist power Pm and an engine fuel efficiency h;

FIG. 11 is a graph that schematically illustrates one example of a correspondence relationship among engine power, motor assist power Pm and “h·Pe”;

FIG. 12 is a graph that schematically illustrates one example of a correspondence relationship among engine power, motor assist power Pm and “h−F/η”;

FIG. 13 is a graph that schematically illustrates one example of a correspondence relationship among engine power, motor assist power Pm and “−(h−F/η)·Pm”;

FIG. 14 is a graph that schematically illustrates one example of a correspondence relationship among engine power, motor assist power Pm and a vehicle fuel consumption amount Q2; and

FIG. 15 is a flowchart (second) that illustrates one example of a processing procedure by ECU.

### DETAILED DESCRIPTION OF EMBODIMENTS

An embodiment of this disclosure is hereinafter described in detail with reference to the drawings. The same or corresponding parts are designated by the same reference numerals in all the drawings and their description is not repeated.

The term “electric power” as used herein sometimes means electric power in a narrow sense (power) and sometimes means electric power in a wide sense, i.e., an amount of electric power (amount of work) or electric energy, and should be flexibly interpreted depending on the situation in which the term is used.

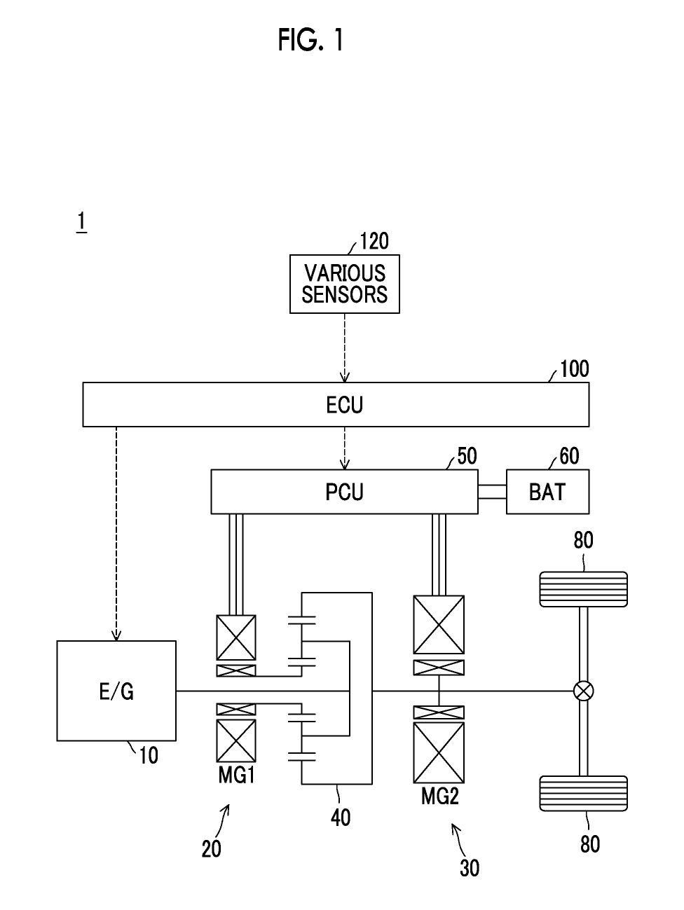

FIG. 1 is an entire configuration diagram of a vehicle 1 according to this embodiment. A vehicle 1 is equipped with an engine 10, a first motor generator (which is hereinafter referred to as “first MG”) 20, a second motor generator (which is hereinafter referred to as “second MG”) 30, a power split device 40, a PCU (Power Control Unit) 50, a battery 60, driving wheels 80, and an ECU (Electronic Control Unit) 100.

The vehicle 1 is what is called a split-type hybrid vehicle that is equipped with the engine 10 and two motor generators (the first MG20 and the second MG30). A vehicle to which this disclosure is applicable is not limited to the vehicle 1 as shown in FIG. 1. For example, this disclosure is applicable to an ordinary series-type or parallel-type hybrid vehicle that is equipped with an engine and one motor generator.

The engine 10 is an internal combustion engine that outputs power by converting combustion energy that is generated when a mixture of air and fuel is combusted into motion energy of moving elements such as pistons and rotors. The power split device 40 includes a planetary gear mechanism that has three rotating shafts for a sun gear, a carrier and a ring gear. The power split device 40 splits power from the engine 10 into power for driving the first MG20 and power for driving the driving wheels 80.

Each of the first MG20 and the second MG30 is an AC rotating electric machine, and is a three-phase AC synchronous electric motor in which permanent magnets are embedded in a rotor, for example. The first MG20 is primarily used as an electric generator that is driven by the engine 10 via the power split device 40. In the following, electric generation in the first MG20 that involves fuel consumption in the engine 10 is also referred to as “engine electric generation,” and the electric power that is generated by the first MG20 through the engine electric generation is also referred to as “engine-generated electric power.” The engine-generated electric power is supplied to the second MG30 or the battery 60 via the PCU 50.

The second MG30 primarily operates as an electric motor to drive the driving wheels 80. The second MG30 is driven by either or both of electric power from the battery 60 and electric power that is generated by the first MG20, and driving force of the second MG30 is transmitted to the driving wheels 80. On the other hand, when the vehicle 1 is braked or its acceleration is decreased as the vehicle 1 is running downslope, the second MG30 is driven by rotation energy of the driving wheels 80 (operational energy of the vehicle 1) and regeneratively generates electric power. In the following, the regenerative electric power that is generated by the second MG30 is also referred to as “MG2 regenerative electric power”. The MG2 regenerative electric power is recovered into the battery 60 via the PCU 50. Thus, both electric power that is obtained using fuel for the engine 10 (engine-generated electric power) and electric power that is obtained using operational energy of the vehicle 1 without using fuel for the engine 10 (MG2 regenerative electric power) are stored in the battery 60.

The PCU 50 converts DC electric power from the battery 60 into AC electric power for driving the first MG20 and the second MG30. The PCU 50 also converts AC electric power that is generated by the first MG20 and the second MG30 into DC electric power for charging the battery 60. The PCU 50 includes, for example, two inverters that are provided corresponding to the first MG20 and the second MG30, and a converter that boosts a DC voltage that is supplied to each inverter to a voltage of the battery 60 or higher.

The battery 60 is a rechargeable DC power source, and includes a secondary battery such as a lithium ion cell or nickel hydrogen cell. The battery 60 is charged with electric power that is generated by at least one of the first MG20 and the second MG30. The battery 60 supplies the stored electric power to the PCU 50. As the battery 60, an electric double-layer capacitor or the like may be employed.

The vehicle 1 is also provided with various sensors 120. The various sensors 120 include, for example, an accelerator operation amount sensor that detects an amount by which an accelerator is being operated by a user, a rotational speed sensor that detects a rotational speed of the engine 10, a vehicle speed sensor that detects a vehicle speed, a monitoring unit that detects states of the battery 60 (voltage, input/output currents and temperature) and so on. The various sensors 120 output a detection result to the ECU 100.

The ECU 100 includes a CPU (Central Processing Unit), ROM (Read Only Memory) in which processing programs and so on are stored, RAM (Random Access Memory) in which data are temporarily stored, an input/output port (not shown) through which various signals are input and output, and so on, and executes predetermined arithmetic processing based on information that has been stored in the memories (ROM and RAM) and information from the various sensors 120. The ECU 100 controls various machines and devices including the engine 10 and the PCU 50 based on a result of the arithmetic processing.

Calculation of Battery Equivalent Fuel Efficiency

The ECU 100 according to this embodiment calculates a “battery equivalent fuel efficiency F” as an indicator that indicates a quality of electric power that is stored in the battery 60. The battery equivalent fuel efficiency F is represented by a ratio (unit: g/kWh) of the amount of fuel that was consumed in the engine 10 to charge the battery 60 to a total amount of electric power that is stored in the battery 60. In other words, the battery equivalent fuel efficiency F is an indicator that indicates how many grams of fuel are consumed in the engine 10 to consume a unit amount (1 kWh) of energy in the battery 60.

The electric power that is stored in the battery 60 is the sum of the engine-generated electric power (electric power that is obtained using fuel for the engine 10) as described above and MG2 regenerative electric power (electric power that is obtained without using fuel for the engine 10) as described above. In calculating the battery equivalent fuel efficiency F, when the battery 60 is charged with the engine-generated electric power, the fuel corresponding to the engine-generated electric power is regarded as being stored together into the battery 60, and when electric power is output from the battery 60, the fuel corresponding to the output electric power is regarded as being consumed together.

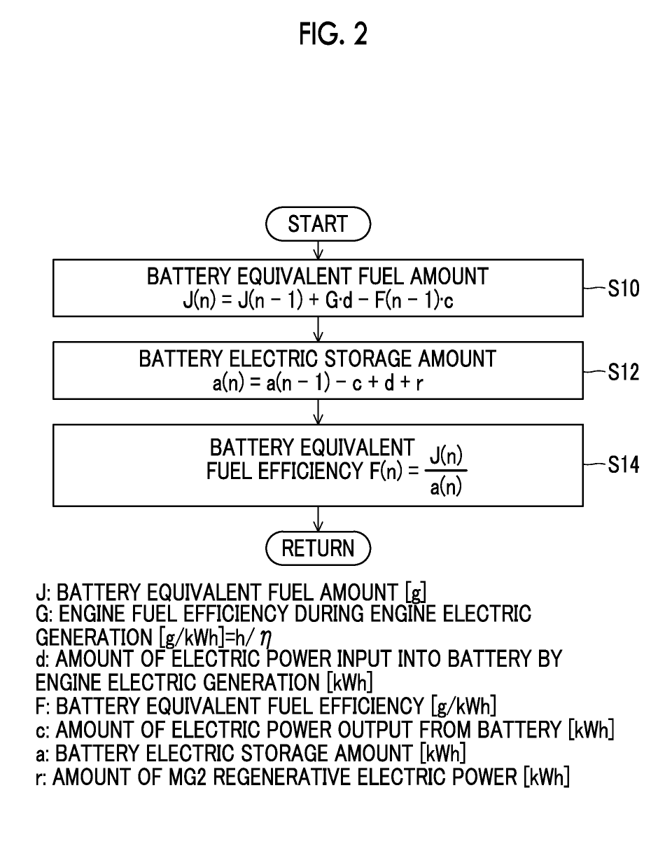

FIG. 2 is a flowchart that illustrates one example of a processing procedure that the ECU 100 executes in calculating a battery equivalent fuel efficiency F. This flowchart is repeatedly executed at predetermined cycles.

In step (in the following, the word step is abbreviated as “S”) 10, the ECU 100 calculates a battery equivalent fuel amount J₍ₙ₎ (unit: g) of this cycle according to the following equation (1).

J₍ₙ₎=J₍ₙ₋₁₎+G·d−F₍ₙ₋₁₎·c (1)

In equation (1), “J₍ₙ₋₁₎” is a battery equivalent fuel amount J (unit: g) of the previous cycle.

“d” is the amount of electric power (unit: kWh) that was input into the battery 60 by the engine electric generation between the previous cycle and the current cycle. “G” is a fuel efficiency (unit: g/kWh) of the engine 10 during the engine electric generation between the previous cycle and the current cycle. The “G” is a value that is calculated in consideration of electric system loss, and is expressed as G=h/η using an engine fuel efficiency h and an electric system efficiency η, which are described later. The “G·d” in equation (1) is an equivalent fuel amount (unit: g) that was input into the battery 60 between the previous cycle and the current cycle.

“c” is the amount of electric power (unit: kWh) that was output from the battery 60 between the previous cycle and the current cycle. “F₍ₙ₋₁₎”is the battery equivalent fuel efficiency F (unit: g/kWh) of the previous cycle. Thus, the “F₍ₙ₋₁₎·c” in equation (1) is an equivalent fuel amount (unit: g) that was output from the battery 60 between the previous cycle and the current cycle.

Then, the ECU 100 calculates a battery electric storage amount a₍ₙ₎ (unit: kWh) of the current cycle according to the following equation (2) (S12).

a₍ₙ₎=a₍ₙ₋₁₎−c+d+r (2)

In equation (2), “a₍ₙ₋₁₎” is a battery electric storage amount (unit: kWh) of the previous cycle. “c” is the amount of electric power (unit: kWh) that was output from the battery 60 between the previous cycle and the current cycle as described above. “d” is the amount of electric power (unit: kWh) that was input into the battery 60 by the engine electric generation between the previous cycle to the current cycle as described above. “r” is the amount of electric power (unit: kWh) that was input into the battery 60 by the MG2 regenerative electric generation between the previous cycle and the current cycle. In other words, the battery electric storage amount a is calculated in consideration of the amount of electric power that was output from the battery 60 (=c), the amount of electric power that was input into the battery 60 by the engine electric generation (=d) and the amount of electric power that was input into the battery 60 by the MG2 regenerative electric generation (=r).

Then, the ECU 100 calculates a value that is obtained by dividing the battery equivalent fuel amount J₍ₙ₎ of the current cycle that is calculated in S10 by the battery electric storage amount a₍ₙ₎ of the current cycle that is calculated in S12 as a battery equivalent fuel efficiency F₍ₙ₎ (unit: g/kWh) of the current cycle as shown by the following equation (3) (S14).

F₍ₙ₎=J₍ₙ₎/a₍ₙ₎ (3)

When the amount of electric power that is input into the battery 60 by the MG2 regenerative electric generation (=r) increases, the “battery equivalent fuel amount J₍ₙ₎,” which is calculated according to equation (1), does not increase whereas the “battery electric storage amount a₍ₙ₎,” which is calculated according to equation (2), increases. As a result, the “battery equivalent fuel efficiency F₍ₙ₎” (=J₍ₙ₎/a₍ₙ₎), which is calculated according to equation (3), decreases. Thus, as the amount of electric power that is input into the battery 60 by the MG2 regenerative electric generation (=r) is greater, the battery equivalent fuel efficiency F has a lower value.

Engine Power Control

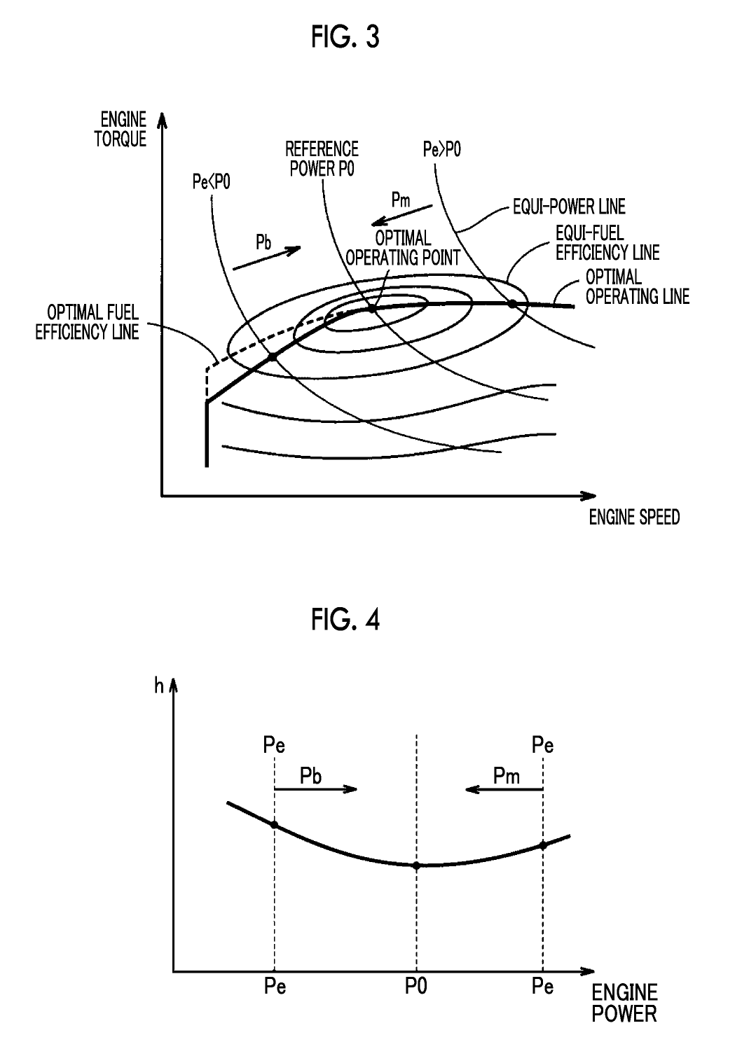

FIG. 3 is a graph for explaining one example of engine power control that is executed by the ECU 100 according to this embodiment.

In FIG. 3, the horizontal axis represents the rotational speed of the engine 10 (which is hereinafter referred to also as “engine speed”), and the vertical axis represents the torque of the engine 10 (which is hereinafter referred to also as “engine torque”). Thus, operating conditions of the engine 10 that are determined by the engine speed and the engine torque (which are hereinafter referred to as “engine operational points”) are shown in FIG. 3.

“Equi-fuel efficiency lines” that are shown in FIG. 3 are lines that are obtained by connecting engine operational points with an identical engine fuel efficiency h. Here, the engine fuel efficiency h means an amount of fuel that is necessary for the engine 10 to generate a unit amount (1 kWh) of power (unit: g/kWh). An equi-fuel efficiency line with a smaller elliptical area indicates that the engine 10 has a higher heat efficiency and the engine fuel efficiency h has a smaller value. Thus, the region that is surrounded by the innermost elliptical equi-fuel efficiency line is the region with the lowest engine fuel efficiency h.

An “optimal fuel efficiency line” that is shown in FIG. 3 is a line obtained by connecting engine operating points with a minimum engine fuel efficiency h for each engine speed. An “optimal operating line” that is shown in FIG. 3 is an operating line of the engine 10 that is previously determined by a designer on the basis of the optimal fuel efficiency line so that no NV (noise and vibration) can be generated in the engine 10 in a low-rotational speed region. The ECU 100 controls the engine speed and the engine torque so that the engine 10 can be operated on the optimal operating line.

Because engine power is determined by a product of the engine speed and the engine torque, the engine power can be represented by an inverse proportional curve in FIG. 3. When the engine power at which the engine 10 has an optimal heat efficiency value is defined as “reference power P0,” the intersection between an inverse proportional curve that represents the reference power P0 and the optimal operating line is an optimal operating point at which the engine fuel efficiency h is minimum.

FIG. 4 is a graph that illustrates a correspondence relationship between the engine power and the engine fuel efficiency h that is obtained when the engine 10 is operated on the optimal operating line. As shown in FIG. 4, the engine fuel efficiency h has a minimum value when the engine power is equal to the reference power P0, and has a greater value as the engine power departs from the reference power P0.

Thus, when the power the user requests from the vehicle 1 (which is hereinafter referred to as “requested power Pe”) is different from the reference power P0, if the engine power is directly set to the requested power Pe, the engine fuel efficiency h cannot have a minimum value.

Thus, when the requested power Pe is different from the reference power P0, the ECU 100 according to this embodiment makes the engine power closer to the reference power P0 (in other words, makes the engine fuel efficiency h to a minimum value) by adding charge power to the battery 60 to the requested power Pe or subtracting output power from the battery 60 from the requested power Pe.

Specifically, when the requested power Pe is lower than the reference power P0, the ECU 100 sets a value that is calculated by adding “engine electric generation power Pb” to the requested power Pe (=Pe+Pb) as the engine power. Here, the “engine electric generation power Pb” is engine power that is used for engine electric generation in order to charge the battery 60. In this way, when Pe<P0, the engine power can be made closer to the reference power P0 by setting “Pe+Pb” as the engine power. At this time, the power corresponding to the requested power Pe in the engine power is converted into energy that is used to propel the vehicle 1, and the power corresponding to the engine electric generation power Pb is converted into electric power that is charged into the battery 60.

On the other hand, when the requested power Pe is higher than the reference power P0, the ECU 100 sets a value that is calculated by subtracting “motor assist power Pm” from the requested power Pe (=Pe−Pm) as the engine power. Here, the “motor assist power Pm” is running power that is assisted by the second MG30, which is driven using electric power from the battery 60. In this way, when Pe>P0, the engine power can be made closer to the reference power P0 by setting “Pe−Pm” as the engine power. At this time, running power corresponding to the requested power Pe is provided by both the engine power and the motor assist power Pm.

Calculation of Engine Electric Generation Power Pb and Motor Assist Power Pm

As described above, when the requested power Pe is different from the reference power P0, the ECU 100 according to this embodiment makes the engine power closer to the reference power P0 by setting a value that is calculated by adding the engine electric generation power Pb to the requested power Pe as the engine power or setting a value that is calculated by subtracting the motor assist power Pm from the requested power Pe as the engine power.

At this time, if the engine electric generation power Pb or the motor assist power Pm is simply determined so that the engine power can be equal to the reference power P0, an actual fuel consumption amount in the engine 10 can be reduced to a minimum value but a battery equivalent fuel consumption amount that is calculated in consideration of electrical loss and the battery equivalent fuel efficiency F may increase excessively. As a result, it is concerned that a fuel consumption amount in the entire vehicle that is calculated in consideration of both the fuel consumption amount in the engine 10 and a battery equivalent fuel consumption amount (which is hereinafter referred to as “vehicle fuel consumption amount Q”) may not reach a minimum value.

Thus, in this embodiment, engine electric generation power Pb or motor assist power Pm at which the vehicle fuel consumption amount Q has a minimum value is searched (calculated), and the searched result is used to set the engine power. In the following, methods for calculating the engine electric generation power Pb and the motor assist power Pm are described in detail.

Calculation of Engine Electric Generation Power Pb

First, a method for calculating the engine electric generation power Pb is described. As described above, when the requested power Pe is lower than the reference power P0, a value that is calculated by adding the engine electric generation power Pb to the requested power Pe (=Pe+Pb) is set as the engine power. Thus, when the requested power Pe is lower than the reference power P0, an actual fuel consumption amount q1 in the engine 10 is represented by the following equation (4).

q1=h·(Pe+Pb)=h·Pe+h·Pb (4)

In equation (4), “h·Pe” is a fuel consumption amount that is used in the engine 10 to propel the vehicle, and “h·Pb” is a fuel consumption amount that is used in the engine 10 for the engine electric generation.

Here, the fuel consumption amount “h·Pb” that is used for the engine electric generation is converted into electric power and then stored in the battery 60. A value that is calculated by multiplying the engine electric generation power Pb by an electric system efficiency η (=Pb·η) is electric power that is generated by consuming fuel and input into the battery 60. A value that is calculated by multiplying the engine fuel efficiency h by the engine electric generation power Pb (=h·Pb) is the amount of fuel that is consumed in the engine 10 to charge the battery 60, and this value is regarded as an equivalent fuel amount that is input into the battery 60.

The equivalent fuel amount that is stored in the battery 60 is a value that is calculated by converting the electric power that is input into the battery by consuming fuel (=Pb·η) into an equivalent fuel consumption amount at the time of output from the battery 60. Thus, the equivalent fuel consumption amount that is stored in the battery 60 is a value that is obtained by multiplying the electric power that is input into the battery by consuming fuel (=Pb·η) by the battery equivalent fuel efficiency F at that point in time (=F·Pb·η).

A vehicle fuel consumption amount Q that is calculated in consideration of both the actual fuel consumption amount q1 in the engine 10 and the equivalent fuel consumption amount that is stored in the battery 60 (which is hereinafter referred to as “vehicle fuel consumption amount Q1”) can be represented by the following equation (5), and the following equation (5A) is derived by transforming equation (5).

Q1=h·(Pe+Pb)−F·Pb·η (5)

Q1=h·Pe+(h−F·η)·Pb (5A)

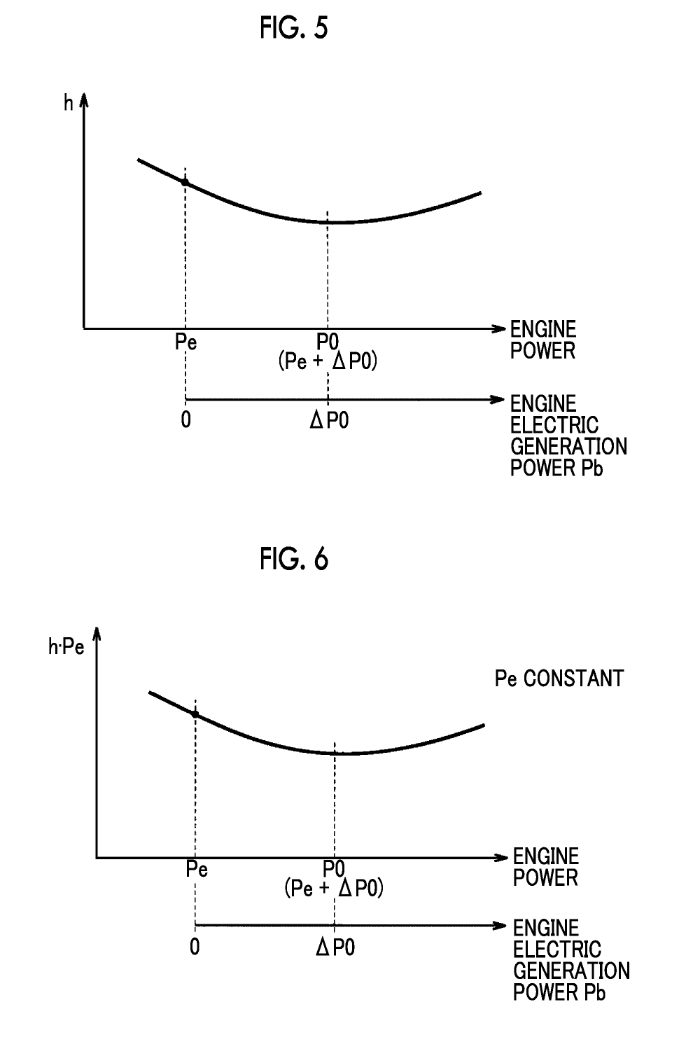

In equations (5) and (5A), when the engine electric generation power Pb is varied as a parameter, the vehicle fuel consumption amount Q1 has a minimum value Q1min when the engine electric generation power Pb has a certain value. The engine electric generation power Pb at which the vehicle fuel consumption amount Q1 has the minimum value Q1min is optimal engine electric generation power Pbmin. With regard to this point, detailed description is made with reference to FIG. 5 to FIG. 9.

FIG. 5 is a graph that schematically illustrates one example of a correspondence relationship among the engine power, the engine electric generation power Pb and the engine fuel efficiency h. As shown in FIG. 5, the engine fuel efficiency h has a minimum value when the engine power is equal to the reference power P0. Thus, when the requested power Pe is lower than the reference power P0, the engine fuel efficiency h has a minimum value by adding a difference ΔP0 between the requested power Pe and the reference power P0 to the requested power Pe (in other words, by setting the engine electric generation power Pb to the difference ΔP0). In other words, when the engine electric generation power Pb is increased from 0 (in other words, the engine power is increased from the requested power Pe), the engine fuel efficiency h decreases until the engine electric generation power Pb reaches the difference ΔP0 and increases after the engine electric generation power Pb exceeds the difference ΔP0.

FIG. 6 is a graph that schematically illustrates one example of a correspondence relationship among the engine power, the engine electric generation power Pb and the “h·Pe” in equation (5A). Because the requested power Pe can be regarded as being constant when the vehicle fuel consumption amount Q1 is calculated, the “h·Pe” that is shown in FIG. 6 is a value that is calculated by multiplying the “h” that is shown in FIG. 5 by a constant value Pe. Thus, as shown in FIG. 6, when the engine electric generation power Pb is increased from 0, the “h·Pe” also decreases until the engine electric generation power Pb reaches the difference ΔP0 and increases after the engine electric generation power Pb exceeds the difference ΔP0.

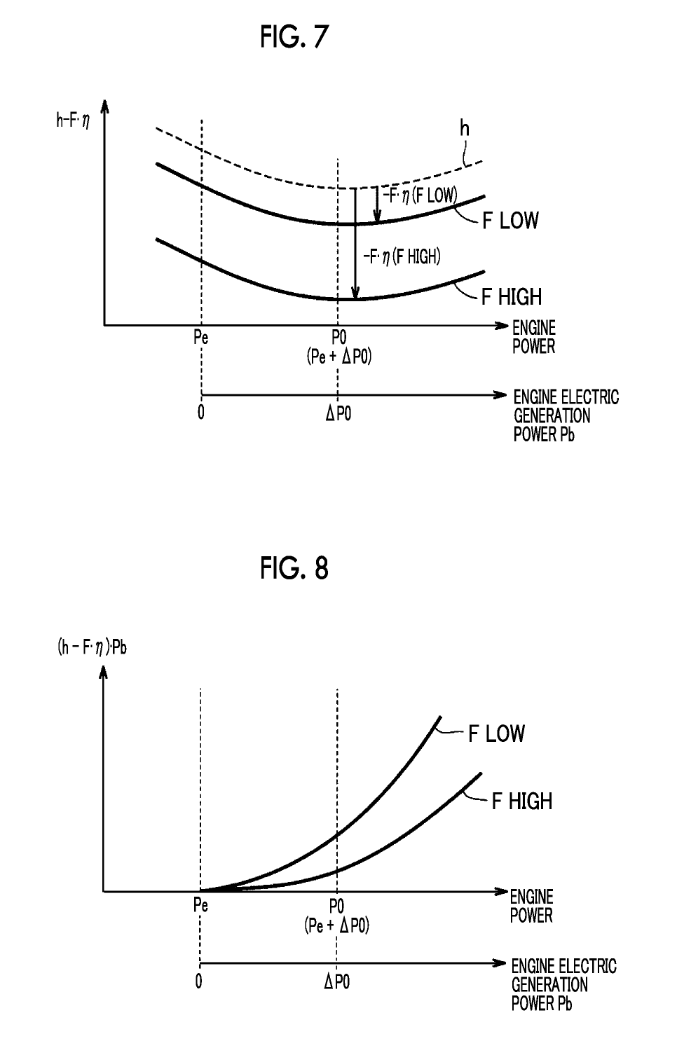

FIG. 7 is a graph that schematically illustrates one example of a correspondence relationship among the engine power, the engine electric generation power Pb and the “h−F·η” in equation (5A). The “h” that is indicated by a broken line in FIG. 7 is the same as the engine fuel efficiency h that is indicated by a solid line in FIG. 5 as described above. In other words, when the engine electric generation power Pb is increased from 0, the “h” that is indicated by a broken line in FIG. 7 decreases until the engine electric generation power Pb reaches the difference ΔP0 and increases after the engine electric generation power Pb exceeds the difference ΔP0.

Because the battery equivalent fuel efficiency F and the electric system efficiency η can be both regarded as being constant when the vehicle fuel consumption amount Q1 is calculated, the “F·η” can be regarded as being constant. Thus, as shown in FIG. 7, when the engine electric generation power Pb is increased from 0, the “h−F·η” decreases until the engine electric generation power Pb reaches the difference ΔP0 and increases after engine electric generation power Pb exceeds the difference ΔP0.

As described previously, the battery equivalent fuel efficiency F may vary depending on the MG2 regenerative electric generation amount. For example, when the MG2 regenerative electric generation amount increases, the battery equivalent fuel amount J does not increase whereas the battery equivalent fuel efficiency F (=J/a) decreases because the battery electric storage amount a increases (refer to the above equations (1) to (3)). Thus, as shown in FIG. 7, the “h−F·η” which is obtained when the MG2 regenerative electric generation amount is large and the battery equivalent fuel efficiency F is low has a greater value than the “h−F·η” which is obtained when the MG2 regenerative electric generation amount is small and the battery equivalent fuel efficiency F is high.

FIG. 8 is a graph that schematically illustrates one example of a correspondence relationship among the engine power, the engine electric generation power Pb and the “(h−F·η)·Pb” in equation (5A). As shown in FIG. 8, the “(h−F·η)·Pb” is 0 when the engine electric generation power Pb is 0 and monotonically increases from 0 when the engine electric generation power Pb is increased from 0.

As shown in FIG. 7 as described above, the “h−F·n” which is obtained when the battery equivalent fuel efficiency F is low has a greater value than the “h−F·n” which is obtained when the battery equivalent fuel efficiency F is high. Thus, as shown in FIG. 8, the “(h−F·N)·Pb” which is obtained when the battery equivalent fuel efficiency F is low has a greater value than the “h−F·η” which is obtained when the battery equivalent fuel efficiency F is high.

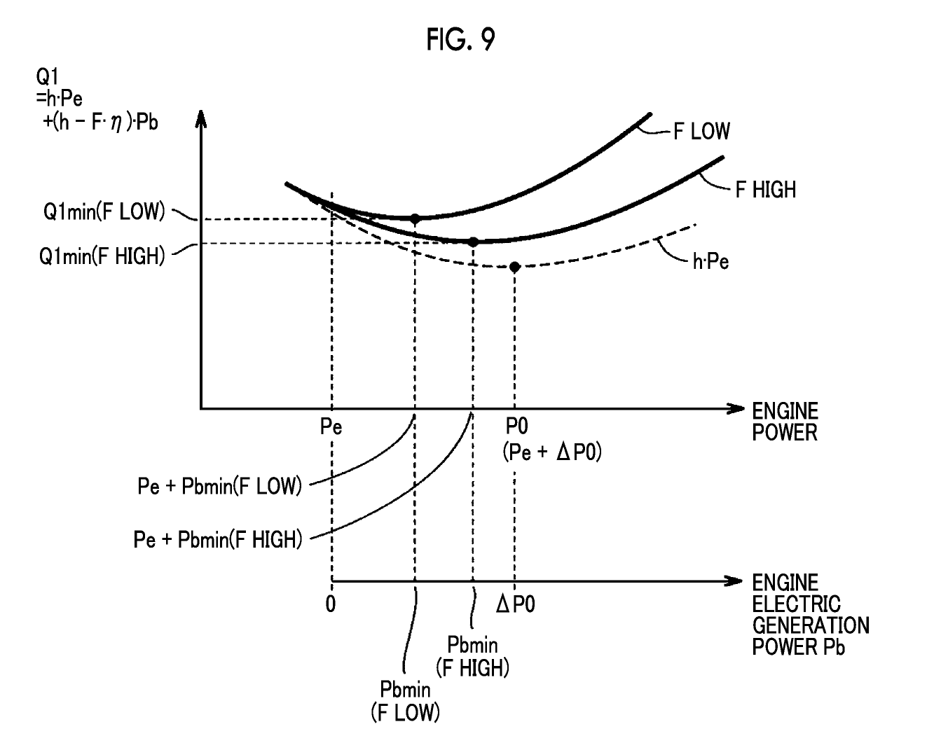

FIG. 9 is a graph that schematically illustrates one example of a correspondence relationship among the engine power, the engine electric generation power Pb and the vehicle fuel consumption amount Q1. The vehicle fuel consumption amount Q1 that is shown in FIG. 9 has a waveform that is obtained by synthesizing the waveform of “h·Pe” that is shown in FIG. 6 and the waveform of “(h−F·η)·Pb” that is shown in FIG. 8.

As can be understood from the waveform that is shown in FIG. 9, when the engine electric generation power Pb is increased from 0 (in other words, the engine power is increased from the requested power Pe), the vehicle fuel consumption amount Q1 has the minimum value Q1min when the engine electric generation power Pb has a certain value. The engine electric generation power Pb at which the vehicle fuel consumption amount Q1 has the minimum value Q1min is “optimal engine electric generation power Pbmin”.

In addition, as can be understood from the waveform that is shown in FIG. 9, the optimal engine electric generation power Pbmin has a smaller value than the difference ΔP0. This means that the fuel consumption amount in the entire vehicle can be reduced when the engine power is set to “Pe+Pbmin,” which is lower than the reference power P0, compared to when the engine power is set to the reference power P0 (=Pe+ΔP0).

In addition, as can be understood from the waveform that is shown in FIG. 9, the optimal engine electric generation power Pbmin which is obtained when the battery equivalent fuel efficiency F is low has a smaller value than the optimal engine electric generation power Pbmin which is obtained when the battery equivalent fuel efficiency F is high. This means that the fuel consumption amount in the entire vehicle can be reduced when the engine electric generation power Pb is decreased as the MG2 regenerative electric generation amount is greater and the battery equivalent fuel efficiency F is lower.

In view of the above, when the requested power Pe is lower than the reference power P0, the ECU 100 according to this embodiment calculates the vehicle fuel consumption amount Q1 using the engine electric generation power Pb as a parameter according to equation (5) as described above, searches (calculates) the engine electric generation power Pb at which the vehicle fuel consumption amount Q1 has the minimum value Q1min, and sets the searched value as the optimal engine electric generation power Pbmin.

Calculation of Motor Assist Power Pm

Next, a method for calculating the motor assist power Pm is described. As described above, when the requested power Pe is higher than the reference power P0, a value that is calculated by subtracting the motor assist power Pm from the requested power Pe (=Pe−Pm) is set as the engine power. Thus, when the requested power Pe is higher than the reference power P0, an actual fuel consumption amount q2 in the engine 10 is represented by the following equation (6).

q2=h·(Pe−Pm) (6)

Because the motor assist power Pm is running power that is assisted by the second MG30, a value that is calculated by dividing the motor assist power Pm by the electric system efficiency η (=Pm/η) is the electric power that is output from the battery 60 to obtain the motor assist power Pm, and a value that is obtained by multiplying the value by battery equivalent fuel efficiency F (=F·Pm/η) is the equivalent fuel amount that is output from the battery 60.

Thus, a vehicle fuel consumption amount Q that is calculated in consideration of both the actual fuel consumption amount q2 in the engine 10 and the equivalent fuel consumption amount that is output from the battery 60 (which is hereinafter referred to as “vehicle fuel consumption amount Q2”) can be represented by the following equation (7), and the following equation (7A) is derived by transforming equation (7).

Q2=h·(Pe−Pm)+F·Pm/η (7)

Q2=h·Pe−(h−F/η)·Pm (7A)

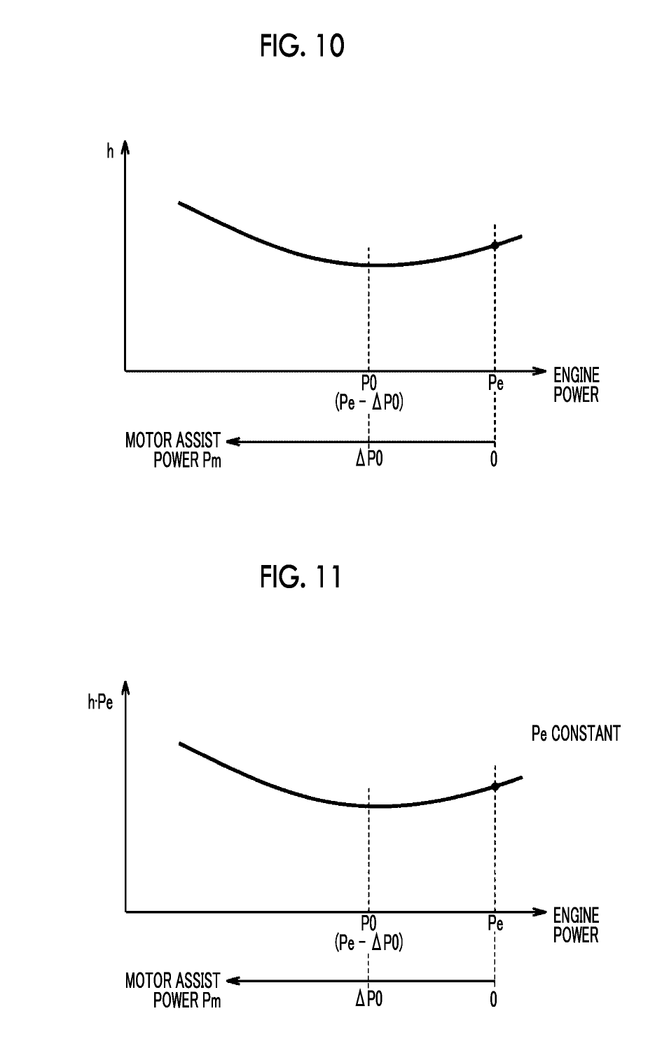

FIG. 10 is a graph that schematically illustrates one example of a correspondence relationship among the engine power, the motor assist power Pm and the engine fuel efficiency h. As shown in FIG. 10, the engine fuel efficiency h is minimum when the engine power is equal to the reference power P0. Thus, when the requested power Pe is higher than reference power P0, the engine fuel efficiency h has a minimum value by subtracting a difference ΔP0 between the requested power Pe and the reference power P0 from the requested power Pe (in other words, by setting the motor assist power Pm to the difference ΔP0). In other words, when the motor assist power Pm is increased from 0 (in other words, the engine power is decreased from the requested power Pe), the engine fuel efficiency h decreases until the motor assist power Pm reaches the difference ΔP0 and increases after the motor assist power Pm exceeds the difference ΔP0.

FIG. 11 is a graph that schematically illustrates one example of a correspondence relationship among the engine power, the motor assist power Pm and the “h·Pe” in equation (7A). Because the requested power Pe can be regarded as being constant when the vehicle fuel consumption amount Q2 is calculated, the “h·Pe” that is shown in FIG. 11 is a value that is calculated by multiplying the “h” that is shown in FIG. 10 by a constant value Pe. Thus, as shown in FIG. 11, when the motor assist power Pm is increased from 0, the “h·Pe” also decreases until the motor assist power Pm reaches the difference ΔP0 and increases after the motor assist power Pm exceeds the difference ΔP0.

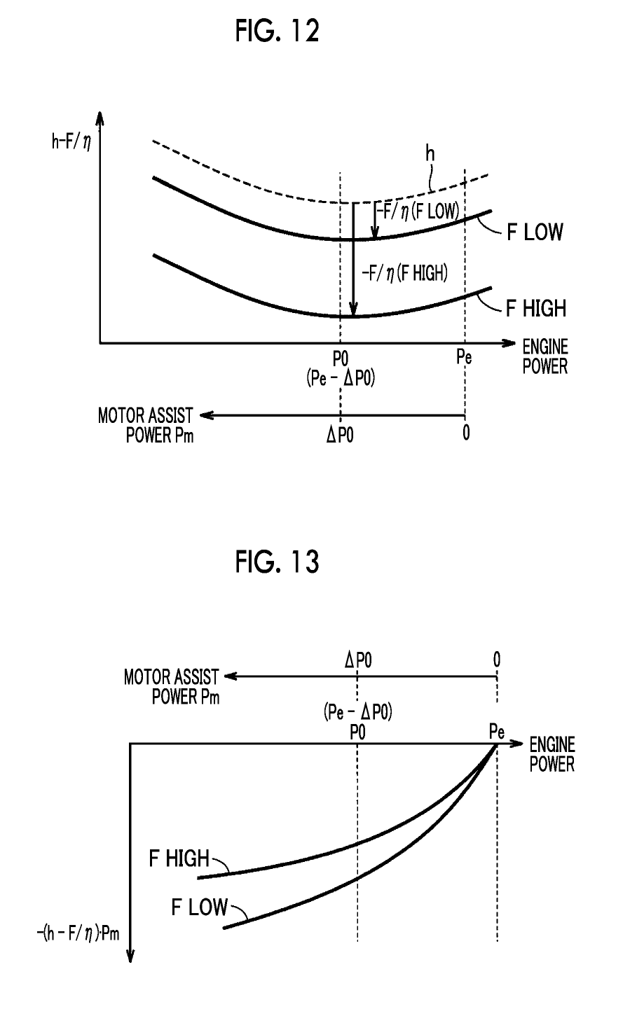

FIG. 12 is a graph that schematically illustrates one example of a correspondence relationship among the engine power, the motor assist power Pm and the “h−F/η” in equation (7A). The “h” that is indicated by a broken line in FIG. 12 is the same as the engine fuel efficiency h that is indicated by a solid line in FIG. 11 as described above. In other words, when the motor assist power Pm is increased from 0, the “h” that is indicated by a broken line in FIG. 12 decreases until the motor assist power Pm reaches the difference ΔP0 and increases after the motor assist power Pm exceeds the difference ΔP0.

Because the “F/η” can be regarded as being constant when the vehicle fuel consumption amount Q2 is calculated. Thus, as shown in FIG. 12, when the motor assist power Pm is increased from 0, the “h−F/n” decreases until the motor assist power Pm reaches the difference ΔP0 and increases after the motor assist power Pm exceeds the difference ΔP0.

As described previously, the battery equivalent fuel efficiency F may vary depending on the MG2 regenerative electric generation amount. As shown in FIG. 11, the “h−F/η” which is obtained when the MG2 regenerative electric generation amount is large and the battery equivalent fuel efficiency F is low has a greater value than the “h−F/η” which is obtained when the MG2 regenerative electric generation amount is small and the battery equivalent fuel efficiency F is high.

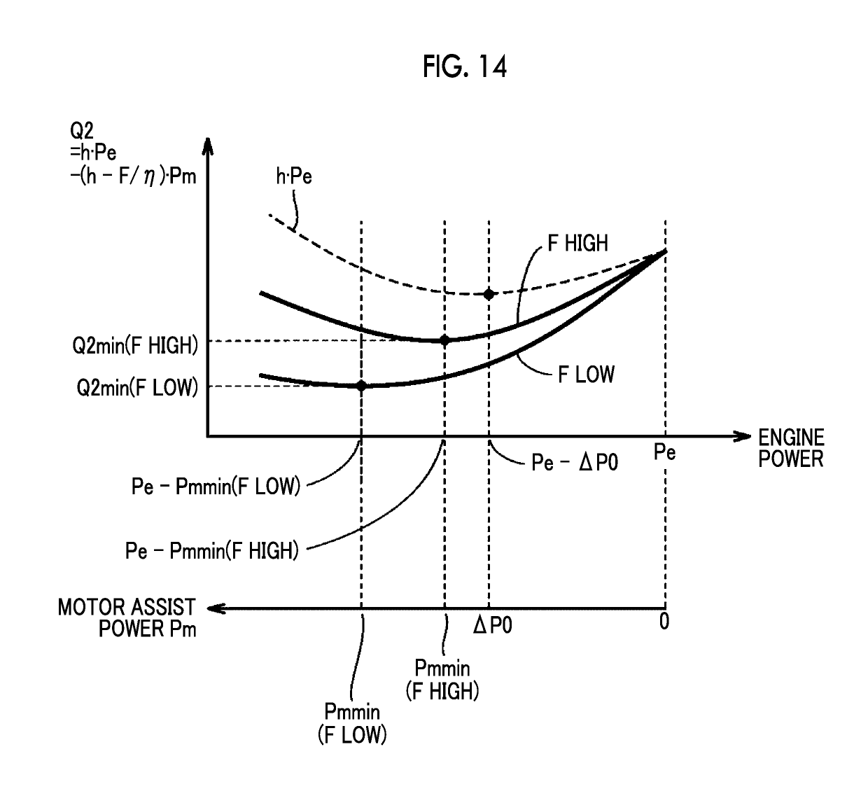

FIG. 13 is a graph that schematically illustrates one example of a correspondence relationship among the engine power, the motor assist power Pm and the “−(h−f/η)·Pm” in equation (7A). As shown in FIG. 13, the “−(h−F/η)·Pm” is 0 when the motor assist power Pm is 0 and monotonically decreases from 0 when the motor assist power Pm is increased from 0 (in other words, when the engine power is decreased from the requested power Pe).

As shown in FIG. 12 as described above, the “h−F·η” which is obtained when the battery equivalent fuel efficiency F is low has a greater value than the “h−F·η” which is obtained when the battery equivalent fuel efficiency F is high. Thus, as shown in FIG. 13, the “−(h−F/η)·Pm” which is obtained when the battery equivalent fuel efficiency F is low has a smaller value than the “−(h−F/η)·Pm” which is obtained when the battery equivalent fuel efficiency F is high.

FIG. 14 is a graph that schematically illustrates one example of a correspondence relationship among the engine power, the motor assist power Pm and the vehicle fuel consumption amount Q2. The vehicle fuel consumption amount Q2 that is shown in FIG. 14 has a waveform that is obtained by synthesizing the waveform of the “h·Pe” that is shown in FIG. 11 and the waveform of the “−(h−F/η)·Pm” that is shown in FIG. 13.

As can be understood from the waveform that is shown in FIG. 14, when the motor assist power Pm is increased from 0 (in other words, the engine power is decreased from the requested power Pe), the vehicle fuel consumption amount Q2 has a minimum value Q2min when the motor assist power Pm has a certain value. The motor assist power Pm at which the vehicle fuel consumption amount Q2 has the minimum value Q2min is “optimal motor assist power Pmmin”.

In addition, as can be understood from the waveform that is shown in FIG. 14, the optimal motor assist power Pmmin has a greater value than the difference ΔP0. This means that the fuel consumption amount in the entire vehicle can be reduced when the engine power is set to “Pe−Pmmin,” which is lower than the reference power P0, compared to when the engine power is simply set to the reference power P0 (=Pe−ΔP0).

In addition, as can be understood from the waveform that is shown in FIG. 14, the optimal motor assist power Pmmin which is obtained when the battery equivalent fuel efficiency F is low has a greater value than the optimal motor assist power Pmmin which is obtained when the battery equivalent fuel efficiency F is high. This means that the fuel consumption amount in the entire vehicle can be reduced when the motor assist power Pm is increased as the MG2 regenerative electric generation amount is greater and the battery equivalent fuel efficiency F is lower.

In view of the above, when the requested power Pe is higher than the reference power P0, the ECU 100 according to this embodiment calculates the vehicle fuel consumption amount Q2 using the motor assist power Pm as a parameter according to equation (7) as described above, searches (calculates) the motor assist power Pm at which the vehicle fuel consumption amount Q2 has the minimum value Q2min, and sets the searched value as the optimal motor assist power Pmmin.

Flowchart of Engine Power Control

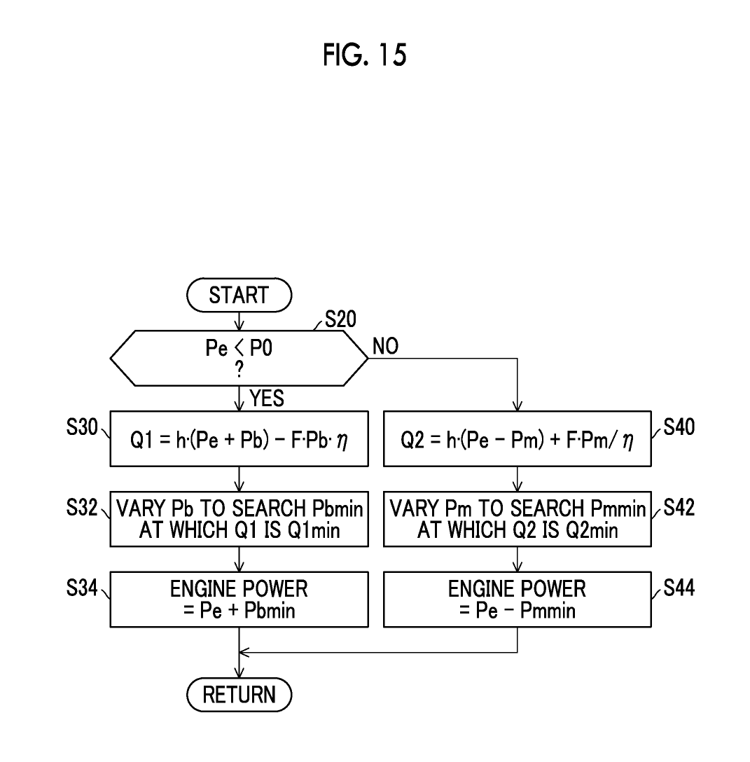

FIG. 15 is a flowchart that illustrates one example of a processing procedure according to which the ECU 100 executes engine power control including the calculation of the engine electric generation power Pb and the motor assist power Pm as described above. This flowchart is repeatedly executed at predetermined cycles while the engine 10 is in operation.

The ECU 100 determines whether the requested power Pe is lower than the reference power P0 (S20). The reference power P0 has been previously recorded in a memory of the ECU 100. The requested power Pe is determined based on the accelerator operation amount and the vehicle speed.

If the requested power Pe is lower than the reference power P0 (YES in S20), the ECU 100 calculates the vehicle fuel consumption amount Q1 using the engine electric generation power Pb as a parameter according to the above equation (5) (S30). In other words, the ECU 100 sets the vehicle fuel consumption amount Q1 to Q1=h·(Pe +Pb)−F·Pb·η.

Then, the ECU 100 varies the engine electric generation power Pb to search the engine electric generation power Pb at which the vehicle fuel consumption amount Q1 has the minimum value Q1min, and sets the searched value as the optimal engine electric generation power Pbmin (S32). Then, the ECU 100 sets a value that is calculated by adding the optimal engine electric generation power Pbmin to the requested power Pe as the engine power (S34).

On the other hand, if the requested power Pe is higher than the reference power P0 (NO in S20), the ECU 100 calculates the vehicle fuel consumption amount Q2 using the motor assist power Pm as a parameter according to the above equation (7) (S40). In other words, the ECU 100 sets the vehicle fuel consumption amount Q2 to Q2=h·(Pe −Pm)+F·Pm/η.

Then, the ECU 100 varies the motor assist power Pm to search the motor assist power Pm at which the vehicle fuel consumption amount Q2 has the minimum value Q2min, and sets the searched value as the optimal motor assist power Pmmin (S42). Then, the ECU 100 sets a value that is calculated by subtracting the optimal motor assist power Pmmin from the requested power Pe as the engine power (S44).

As described above, when the engine 10 is in operation, the ECU 100 according to this embodiment makes the engine power closer to the reference power P0 (makes the heat efficiency of the engine 10 to an optimal value) by adding the engine electric generation power Pb (charge power to the battery 60) to the requested power Pe when the requested power Pe is lower than the reference power P0. At this time, the ECU 100 searches the engine electric generation power Pb at which the vehicle fuel consumption amount Q1, which is calculated in consideration of the actual fuel consumption amount in the engine 10 and the equivalent fuel consumption amount of the battery 60, is minimum as optimal engine electric generation power Pbmin, and causes the engine 10 to output a value that is calculated by adding the optimal engine electric generation power Pbmin to the requested power Pe. Thus, while the engine 10 is in operation, the fuel consumption amount in the entire vehicle can be minimized in consideration of not only the fuel consumption amount in the engine 10 but also the equivalent fuel consumption amount that is stored in the battery 60.

In addition, when the engine 10 is in operation, the ECU 100 makes the engine power closer to the reference power P0 (makes the heat efficiency of the engine 10 to an optimal value) by subtracting the motor assist power Pm (discharge power from the battery 60) from the requested power Pe when the requested power Pe is higher than the reference power P0. At this time, the ECU 100 searches the motor assist power Pm at which the vehicle fuel consumption amount Q2, which is calculated in consideration of the fuel consumption amount in the engine 10 and the equivalent fuel consumption amount of the battery 60, is minimum as optimal motor assist power Pmmin, and causes the engine 10 to output a value that is calculated by subtracting the optimal motor assist power Pmmin from the requested power Pe. Thus, while the engine 10 is in operation, the fuel consumption amount in the entire vehicle can be minimized in consideration of not only the fuel consumption amount in the engine 10 but also the equivalent fuel consumption amount that is consumed by the battery 60.

The embodiment that is disclosed herein should be considered as being illustrative and not limitative in all respects. The scope of this disclosure is shown not by the above description but by accompanying claims, and is intended to include all meanings equivalent to the claims and modifications within the scope thereof.

What is claimed is:

1. A hybrid vehicle, characterized by comprising:
an engine;
a rotating electric machine;
a battery that is electrically connected to the rotating electric machine; and
a controller that is configured to be capable of calculating a battery equivalent fuel efficiency, which is a ratio of an amount of fuel that is consumed in the engine to charge the battery to a total electric power amount that is stored in the battery, wherein:
the hybrid vehicle can run on power from at least one of the engine and the rotating electric machine; and
while the engine is in operation, the controller searches charge/discharge power to/from the battery at which a vehicle fuel consumption amount that is calculated in consideration of a fuel consumption amount in the engine and an equivalent fuel consumption amount that is determined by a product of the battery equivalent fuel efficiency and the charge/discharge power is minimum, and causes the engine to output a value that is calculated by adding the searched charge/discharge power to requested power from a user.

2. The hybrid vehicle according to claim 1, wherein, when the requested power is lower than reference power at which the engine has an optimal heat efficiency value, the controller sets a value that is calculated by subtracting a battery equivalent fuel consumption amount that is determined by a product of the battery equivalent fuel efficiency and charge power that is charged into the battery from a fuel consumption amount that is necessary for the engine to output power that is calculated by adding the charge power to the requested power as a first vehicle fuel consumption amount, searches the charge power at which the first vehicle fuel consumption amount is minimum as optimal charge power, and causes the engine to output a value that is calculated by adding the optimal charge power to the requested power.

3. The hybrid vehicle according to claim 1, wherein, when the requested power is higher than reference power at which the engine has an optimal heat efficiency value, the controller sets a value that is calculated by adding a battery equivalent fuel consumption amount that is determined by a product of the battery equivalent fuel efficiency and discharge power that is discharged from the battery to a fuel consumption amount that is necessary for the engine to output power that is calculated by subtracting the discharge power from the requested power as a second vehicle fuel consumption amount, searches the discharge power at which the second vehicle fuel consumption amount is minimum as optimal discharge power, and causes the engine to output a value that is calculated by subtracting the optimal discharge power from the requested power.
